(19) United States
(12) Patent Application Publication
(10) Pub. No.: US 2026/0093909 A1
(43) Pub. Date: Apr. 2, 2026

(54) SYSTEMS, APPARATUSES, METHODS, AND COMPUTER PROGRAM PRODUCTS FOR AN OMNICHANNEL CONFIGURATION

(71) Applicant: Atlassian Pty, Ltd., Sydney (AU)

(72) Inventors: Gabriel David Tonin Raubenheimer, Sydney (AU); Lauren Jessica Bradley, Sydney (AU); Christopher Charles Mann, Sydney (AU); Shiveen Pandita, Melbourne (AU); Bradley Jay Schoone, Perth (AU)

(21) Appl. No.: 19/341,627

(22) Filed: Sep. 26, 2025

Related U.S. Application Data
(60) Provisional application No. 63/700,360, filed on Sep. 27, 2024.

(51) Int. Cl. G06F 40/186; G06F 21/62

(52) U.S. Cl. CPC G06F 40/186; G06F 21/6209

(57) ABSTRACT

Systems, apparatuses, methods, and computer program products for an omnichannel configuration are provided. A user experience omnichannel generation request may be received. A user experience omnichannel configuration data object may be generated. An experience definition configuration database may be accessed for a plurality of project templates associated with one or more project parameters, omnichannel parameters, and channel parameters. One or more project template selection indications may be received that each identify a selected project template and at least one project parameter, at least one omnichannel parameter, and at least one channel parameters. The user experience omnichannel configuration data object may be updated to store the selected project template associated with at least one project parameter, at least one omnichannel parameter, and at least one channel parameter. The user experience omnichannel configuration data object may be transmitted to a user experience omnichannel configuration database.

### CROSS-REFERENCE TO RELATED APPLICATION(S)

This application claims priority to and the benefit of U.S. Provisional Ser. No. 63/700,360 , filed on Sep. 27, 2024, which is incorporated herein by reference in its entirety.

### BACKGROUND

Service management systems allow for agents to assist with resolving requests submitted to the service management system. Applicant has identified a number of deficiencies and problems associated with effectively, reliably, and securely managing help requests in a service management system. Through applied effort, ingenuity, and innovation, many of these identified deficiencies and problems have been solved by developing solutions that are structured in accordance with the embodiments of the present disclosure, many examples of which are described in detail herein.

### BRIEF SUMMARY

Various embodiments described herein relate to apparatuses, systems, and methods for omnichannel configurations.

In accordance with some embodiments of the present disclosure, an example apparatus is provided. The example apparatus includes at least one processor and at least one non-transitory memory including computer-coded instructions thereon, the computer coded instructions, with the at least one processor, configure the apparatus to: receive, from a first computing device associated with a first leader user account, a user experience omnichannel generation request; generate, in response to receipt of the first user experience omnichannel generation request, a user experience omnichannel configuration data object; access an experience definition configuration database for a plurality of project templates associated with the user experience omnichannel configuration data object, wherein each project template of the plurality of project templates is associated with one or more project parameters, one or more omnichannel parameters, and one or more channel parameters; receive, from the first computing device, one or more project template selection indications, wherein each project template selection indication identifies a selected project template of the plurality of project templates and identifies at least one project parameter, at least one omnichannel parameter, and at least one channel parameters; update the user experience omnichannel configuration data object based on the one or more project template selection indications to store the selected project template associated with at least one project parameter, at least one omnichannel parameter, and at least one channel parameter; and transmit the user experience omnichannel configuration data object to a user experience omnichannel configuration database.

In some embodiments, wherein, for a first selected template, the at least one project parameter includes a first project identifier, the at least one channel parameter includes a first channel identifier and a first issue identifier, and the at least one omnichannel parameter includes a first routing identifier, wherein the routing identifier associates the first channel identifier and first issue identifier with the first project identifier.

In some embodiments, the apparatus is further configured to: receive, from a second computing device associated with an experience user account, a first request data object associated with a request issue identifier via a first channel, wherein the first channel is associated with the first channel identifier, and wherein the request issue identifier is the first issue identifier; access the user experience omnichannel configuration data object from the user experience omnichannel configuration database; determine the first routing identifier based on the user experience omnichannel configuration data object and the first channel identifier and the first issue identifier of the first request data object; and route the first request data object to a first project based on the first routing identifier of the first selected project template.

In some embodiments, wherein route the first request data object to a first project based on the first routing identifier of the first selected project template includes to route the first request data object to an agent account associated with the first project.

In some embodiments, the at least one project parameter includes at least one of a first issue type identifier and a first agent account permission identifier.

In some embodiments, the at least one omnichannel parameter includes at least one of an experience user permission identifier, brand identifier, service identifier, and knowledge base identifier.

In some embodiments, the at least one channel parameter includes at least one of a channel identifier, a priority identifier, and a request template identifier.

In accordance with some embodiments of the present disclosure, an example computer-implemented method is provided. The example computer-implemented method includes: receiving, from a first computing device associated with a first leader user account, a user experience omnichannel generation request; generating, in response to receipt of the first user experience omnichannel generation request, a user experience omnichannel configuration data object; accessing an experience definition configuration database for a plurality of project templates associated with the user experience omnichannel configuration data object, wherein each project template of the plurality of project templates is associated with one or more project parameters, one or more omnichannel parameters, and one or more channel parameters; receiving, from the first computing device, one or more project template selection indications, wherein each project template selection indication identifies a selected project template of the plurality of project templates and identifies at least one project parameter, at least one omnichannel parameter, and at least one channel parameters; updating the user experience omnichannel configuration data object based on the one or more project template selection indications to store the selected project template associated with at least one project parameter, at least one omnichannel parameter, and at least one channel parameter associated with a first channel group; and transmitting the user experience omnichannel configuration data object to a user experience omnichannel configuration database.

In some embodiments, wherein, for a first selected template, the at least one project parameter includes a first project identifier, the at least one channel parameter includes a first channel identifier and a first issue identifier, and the at least one omnichannel parameter includes a first routing identifier, wherein the routing identifier associates the first channel identifier and first issue identifier with the first project identifier.

In some embodiments, the computer-implemented further comprises: receiving, from a second computing device associated with an experience user account, a first request data object associated with a request issue identifier via a first channel, wherein the first channel is associated with the first channel identifier, and wherein the request issue identifier is the first issue identifier; accessing the user experience omnichannel configuration data object from the user experience omnichannel configuration database; determining the first routing identifier based on the user experience omnichannel configuration data object and the first channel identifier and the first issue identifier of the first request data object; and routing the first request data object to a first project based on the first routing identifier of the first selected project template.

In some embodiments, wherein route the first request data object to a first project based on the first routing identifier of the first selected project template includes to route the first request data object to an agent account associated with the first project.

In some embodiments, wherein the at least one project parameter includes at least one of a first issue type identifier and a first agent account permission identifier.

In some embodiments, wherein the at least one omnichannel parameter includes at least one of an experience user permission identifier, brand identifier, service identifier, and knowledge base identifier.

In some embodiments, wherein the at least one channel parameter includes at least one of a channel identifier, a priority identifier, and a request template identifier.

In accordance with some embodiments of the present disclosure, an example computer program product is provided. The example computer program product includes at least one non-transitory computer-readable storage medium having computer-readable program code portions stored therein, the computer-readable program code portions configured to: receive, from a first computing device associated with a first leader user account, a user experience omnichannel generation request; generate, in response to receipt of the first user experience omnichannel generation request, a user experience omnichannel configuration data object; access an experience definition configuration database for a plurality of project templates associated with the user experience omnichannel configuration data object, wherein each project template of the plurality of project templates is associated with one or more project parameters, one or more omnichannel parameters, and one or more channel parameters; receive, from the first computing device, one or more project template selection indications, wherein each project template selection indication identifies a selected project template of the plurality of project templates and identifies at least one project parameter, at least one omnichannel parameter, and at least one channel parameters; wherein the at least one omnichannel parameter is associated with at least a programmatic routing workspace; update the user experience omnichannel configuration data object based on the one or more project template selection indications to store the selected project template associated with at least one project parameter, at least one omnichannel parameter, and at least one channel parameter; and transmit the user experience omnichannel configuration data object to a user experience omnichannel configuration database.

In some embodiments, wherein, for a first selected template, the at least one project parameter includes a first project identifier, the at least one channel parameter includes a first channel identifier and a first issue identifier, and the at least one omnichannel parameter includes a first routing identifier, wherein the routing identifier associates the first channel identifier and first issue identifier with the first project identifier.

In some embodiments, wherein the at least one non-transitory computer-readable storage medium having computer-readable program code portions stored therein, further configure the computer-readable program code portions to: receive, from a second computing device associated with an experience user account, a first request data object associated with a request issue identifier via a first channel, wherein the first channel is associated with the first channel identifier, and wherein the request issue identifier is the first issue identifier; access the user experience omnichannel configuration data object from the user experience omnichannel configuration database; determine the first routing identifier based on the user experience omnichannel configuration data object and the first channel identifier and the first issue identifier of the first request data object; and route the first request data object to a first project based on the first routing identifier of the first selected project template.

In some embodiments, wherein route the first request data object to a first project based on the first routing identifier of the first selected project template includes to route the first request data object to an agent account associated with the first project.

In some embodiments, wherein the at least one project parameter includes at least one of a first issue type identifier and a first agent account permission identifier.

In some embodiments, wherein the at least one omnichannel parameter includes at least one of an experience user permission identifier, brand identifier, service identifier, and knowledge base identifier.

The above summary is provided merely for purposes of summarizing some example embodiments to provide a basic understanding of some aspects of the present disclosure. Accordingly, it will be appreciated that the above-described embodiments are merely examples and should not be construed to narrow the scope or spirit of the present disclosure in any way. It will be appreciated that the scope of the present disclosure encompasses many potential embodiments in addition to those here summarized, some of which will be further described below. Other features, aspects, and advantages of the subject matter will become apparent from the description, the drawings, and the claims.

### BRIEF DESCRIPTION OF THE DRAWINGS

Having thus described certain example embodiments of the present disclosure in general terms above, non-limiting and non-exhaustive embodiments of the subject disclosure will now be described with reference to the accompanying drawings which are not necessarily drawn to scale. The components illustrated in the accompanying drawings may or may not be present in certain embodiments described herein. Some embodiments may include fewer (or more) components than those shown in the figures in accordance with an example embodiment of the present disclosure.

FIG. 1 illustrates an example software management system configured to communicate with client devices in accordance with various example embodiments of the present disclosure;

FIG. 2 illustrates a block diagram of an example computing device in accordance with various example embodiments of the present disclosure;

FIG. 3 illustrates a block diagram schematic of a first omnichannel configuration example of a user experience omnichannel configuration data object in accordance with various example embodiments of the present disclosure;

FIG. 4 illustrates a block diagram schematic of a second omnichannel configuration example of a user experience omnichannel configuration data object in accordance with various example embodiments of the present disclosure;

FIG. 5 illustrates a block diagram schematic of a third omnichannel configuration example of a user experience omnichannel configuration data object in accordance with various example embodiments of the present disclosure;

FIG. 6 illustrates a block diagram schematic of a fourth omnichannel configuration example of a user experience omnichannel configuration data object in accordance with various example embodiments of the present disclosure;

FIG. 7 illustrates a flowchart of operations associated with generating a user experience omnichannel configuration data object in accordance with one or more embodiments of the present disclosure; and

FIG. 8 illustrates a flowchart of operations associated with using a user experience omnichannel configuration data object in accordance with one or more embodiments of the present disclosure.

### DETAILED DESCRIPTION

Some embodiments of the present disclosure will now be described more fully herein with reference to the accompanying drawings, in which some, but not all, embodiments of the disclosure are shown. Indeed, various embodiments of the disclosure may be embodied in many different forms and should not be construed as limited to the embodiments set forth herein; rather, these embodiments are provided so that this disclosure will satisfy applicable legal requirements. Like reference numerals refer to like elements throughout.

### Overview

Methods, apparatuses, systems, and computer program products are provided for an omnichannel configuration for addressing requests received from users. In various embodiments, an omnichannel configuration is generated and used for routing help requests (i.e., request data objects) received from a help seeker (e.g., experience user account) to a relevant help provider or help provider team (e.g., agent account) in a manner that is highly configurable by an administrative user or lead user (e.g., leader user account). The omnichannel configurations allows for the administrative user or leader user (e.g., leader user account) to perform flexible and efficient creation and modification of an omnichannel configuration in a way that is not necessarily perceivable by a help seeker viewing a system user interface, but in a way that efficiently routes a help request to a help provider or help provider team. In various embodiments, and as described further herein, the configurability of the omnichannel configuration is based on specific identifiers that are associated with various portions of the omnichannel configuration, which may allow for routing of a help request based on, among other things, issue, brand, permissions, etc.

An omnichannel configuration is used to receive request data objects associated with requests from user experience accounts. The request data objects are routed to one or more project workspaces according to the omnichannel configuration. As described herein, the routing may be based on, among other things, one or more identifiers described herein that provide data for how the request data objects are to be routed. The generation of the omnichannel configuration may be by a leader account with permissions to generate and configure a user experience omnichannel configuration data object that contain the omnichannel configuration. The user experience omnichannel configuration data object may be stored in a user experience omnichannel configuration database and accessed when a request data object is received.

An omnichannel configuration increases the ability of a service management system to route a request data object to one or more agents associated with one or more project workspaces. An omnichannel configuration as discussed herein is configured to enable the expression of different support models for a support management system that address request data objects that are received. An omnichannel configuration also enables leader user accounts to configure experience user accounts to receive help through any channel and be routed to a project workspace that identifies different parameters and permissions in receiving support for the experience user account without the experience user account having to access or context switch between multiple different systems.

### Definitions

The following explanations of terms are provided to better describe the present disclosure and to guide those of ordinary skill in the art in the practice of the present disclosure.

As used herein, the terms “data,” “content,” “digital content,” “digital content object,” “signal,” “information,” and similar terms may be used interchangeably to refer to data capable of being transmitted, received, and/or stored in accordance with embodiments of the present disclosure. Thus, use of any such terms should not be taken to limit the spirit and scope of embodiments of the present disclosure. Further, where a computing device is described herein to receive data from another computing device, it will be appreciated that the data may be received directly from another computing device or may be received indirectly via one or more intermediary computing devices, such as, for example, one or more servers, relays, routers, network access points, base stations, hosts, and/or the like, sometimes referred to herein as a “network.” Similarly, where a computing device is described herein to send data to another computing device, it will be appreciated that the data may be transmitted directly to another computing device or may be transmitted indirectly via one or more intermediary computing devices, such as, for example, one or more servers, relays, routers, network access points, base stations, hosts, and/or the like.

As used herein, the term “data object” refers to electronically managed data that is computer readable and computer transmittable and represents information or instructions maintained such as described herein. A data object includes data utilized for any of a myriad of functions, including metadata associated with the data object.

As used herein, the term “leader user account” refers to a data structure that is managed by the software management system 110 through which a leader (e.g., enterprise manager, admin user, etc.) is given personalized access to one or more services to which a leader user may implement, edit, and control all project templates, project parameters, omnichannel parameters, channel parameters, user experience omnichannel configuration data objects and experience definition configuration databases to assist in functionality of the omnichannel platform and associated interfaces. For example, in various embodiments, the leader user account may configure the user experience by configuring a user experience omnichannel generation request and generate in response to the user experience omnichannel generation request, a user experience omnichannel configuration data object. The leader user account is then able to access a plurality of project templates through an experience definition configuration database.

As used herein, the term “user experience omnichannel generation request” refers to a one or more items of data indicative of a leader user account making request of an omnichannel creating service to generate a user experience omnichannel configuration data object.

As used herein, the term “user experience omnichannel configuration data object” refers to a one or more items of data indicative of an omnichannel configuration for routing a request data object. The user experience omnichannel configuration data object is generated by an omnichannel generation service, such as by a leader user account using the omnichannel generation service. The user experience omnichannel configuration data object may be used by an omnichannel routing service to route one or more request data objects.

As used herein, the term “experience definition configuration database” refers to a location, such as a data repository stored on a memory device, which is accessible by one or more computing devices for retrieval and storage of data associated with the omnichannel platform. For example, in various embodiments, the experience definition configuration database may include a plurality of project templates associated with the user experience omnichannel configuration data object. Each project template is associated with one or more project parameters, one or more omnichannel parameters, and one or more channel parameters. Thus, the experience definition configuration database the store of data associated with the omnichannel platform includes at least of, a plurality of project templates, project parameters, omnichannel parameters, and channel parameters.

As used herein, the term “project template” refers to one or more items of data indicative of project parameters. For example, in some embodiments the project parameter may consist of an issue type identifier and an agent account permission identifier.

As used herein, the term “project parameter” refers to one or more items of data indicative of one or more project templates stored in the experience definition configuration database. For example, in some embodiments the project parameter may consist of an issue type identifier and an agent account permission identifier.

As used herein, the term “omnichannel parameter” refers to one or more items of data by which a software management system may identify an omnichannel configuration. For example, in various embodiments, the omnichannel parameter may include least one of an experience user permission identifier, brand identifier, service identifier, and knowledge base identifier.

As used herein, the term “project template selection indication” refers to one or more items of data that are selected by the project parameter to be included in the omnichannel configuration.

As used herein, the term “user experience omnichannel configuration database” refers one or more items of data stored on a data repository that create a library of user experience configurations.

As used herein, the term “project identifier” refers to one or more items of data representative of a project within the experience definition configuration database.

As used herein, the term “channel identifier” refers to one or more items of data representative of a channel by which an experience user account or a leader user account are able to acquire access to the omnichannel platform and therefore access help. For example, in various embodiments, the channel parameter may include at least one of a channel identifier, a priority identifier, and a request template identifier.

As used herein, the term “issue identifier” refers to one or more items of a data representative of a problem error, fault, and/or the like requiring analysis, diagnosis, repair, resolution, knowledge, or assistant and/or the like by an experience user account.

As used herein, the term “routing identifier” refers to one or more items of data that when read route a first request data object to a first project based on the first routing identifier of a first selected project template. In various embodiments, a routing identifier may route a first request data object to a first project based on the first routing identifier of a first selected project template that includes to route the first request data object to an agent account associated with the first project.

As used herein, the term “experience user account” refers to one or more users, such as an individual submitting a request data object for assistance with an issue addressed in request data of the request data object.

As used herein, the term “request data object” refers to one or more items of data indicative of a request associated with an experience user account.

As used herein, the term “request issue identifier” refers to one or more items of data associated with a problem, error, fault, and/or the like requiring analysis, diagnosis, repair, resolution, and/or the like by an agent account.

As used herein, the term “agent account” refers to an arrangement by which a user and specifically, a service agent, is given personalized access, in the form of agent permissions, to a computing device, software management system, or network.

As used herein, the term “agent account permission identifier” refers to one or more items of data indicative of an agent account permission.

As used herein, the term “experience user permission identifier” refers to one or more items of data indicative of an experience user permission.

As used herein, the term “brand identifier” refers to one or more items of data indicative of a brand.

As used herein, the term “service identifier” refers to one or more items of data indicative of a service.

As used herein, the term “knowledge base identifier” refers to one or more items of data indicative of a knowledge base.

As used herein, the term “priority identifier” refers to one or more items of data indicative of a priority.

As used herein, the term “request template identifier” refers to one or more items of data indicative of a request template.

As used herein, the term “channel” refers to one or more manner in which a request is received. For example, a channel may refer to an email, a text message, a chat, a phone call, a request submitted via a website, etc.

As used herein, the term “workspace” refers to a digital environment that may be associated with one or more identifiers, accounts, permissions, templates, and/or parameters.

As used herein, the term “external application” refers to a software application or application that is external from one or more system services 114 and that may send or receive one or more data objects from the system services 114 to interact with the system services 114, such as through an API and/or a firewall. An external application is compiled under a different code base from the code bases used to compile the system services 114.

As used herein, the term “AI agent” refers to a computer-implemented process executed by appropriately configured circuitry for obtaining and providing a generative model prompt and/or context data to a large language model and for returning a response. For example, an AI agent may be configured to identify, extract, and or aggregate context data from one or more sources of data to the large language model. In some embodiments, the source of data may include one or more generative model prompts along with additional data. A prompt may be received directly or indirectly from a user via an interface. In some embodiments, the AI agent may be configured to provide data to the large language model and receive a response from the large language model. In some embodiments, an AI agent may output a response that includes, but is not limited to, text, audio, imagery, video, and/or other media related to providing information in response to a prompt, such as a generative model prompt.

In some embodiments, an AI agent may be associated with an AI agent interface where a user may interact with the AI agent interface to provide a user prompt. In some embodiments, an AI agent may generate a generative model prompt based at least on information associated with a user, such as a user prompt, one or more identifiers, and/or data from one or more sources.

As used herein, the term “AI agent source” refers to one or more sources of data associated with an AI agent that is used to generate a generative model prompt. For example, an AI agent source may provide context data that is used to generate a generative model prompt.

As used herein, the term “AI agent request data object” refers to a data object associated with a request and with an AI agent where the AI agent request data object is provided or transmitted to large language model. In some embodiments, an AI agent request data object includes and/or is based at least on a generative model prompt. In some embodiments, an AI agent request data object may include a generative model prompt and additional data associated with the generative model prompt, such as data received from an associated AI agent source.

As used herein, the term “AI agent response data object” refers to a data object received from a large language model based at least on an AI agent request data object provided to the large language model.

As used herein, the term “AI agent interface” refers to an interface that may be rendered on a display that provides for receiving and/or rendering of data associated with a request to an AI agent. In some embodiments, an AI agent interface may be rendered on a user device for a user to enter or provide information or data that will be used to generate a request of an AI agent, which may be used to generate a generative model prompt. The AI agent interface may also render data associated with an AI agent response data object that may be generated based on a generative model prompt.

As used herein, the term “AI agent identifier” refers to an identifier associated with a specific AI agent. In some embodiments, there may be a plurality of AI agents, including a first AI agent and a second AI agent, which may each have a unique identifier, such as a first AI agent identifier and a second AI agent identifier, respectively.

In some embodiments with a plurality of AI agents, a first AI agent may be associated with a first channel and a second AI agent may be associated with a second channel.

As used herein, the term “generative model prompt” refers to a request, prompt, transmission provided or transmitted to a large language model and for returning a response. The generative model prompt may be included in an AI agent request data object. A large language model may generate a generative model response based at least on the generative model prompt.

As used herein, the term “computer-readable storage medium” refers to a non-transitory, physical, or tangible storage medium (e.g., volatile or non-volatile memory), which may be differentiated from a “computer-readable transmission medium,” which refers to an electromagnetic signal. Such a medium may take many forms, including, but not limited to a non-transitory computer-readable storage medium (e.g., non-volatile media, volatile media), and transmission media. Transmission media include, for example, coaxial cables, copper wire, fiber optic cables, and carrier waves that travel through space without wires or cables, such as acoustic waves and electromagnetic waves, including radio, optical, infrared waves, or the like. Signals include man-made, or naturally occurring, transient variations in amplitude, frequency, phase, polarization, or other physical properties transmitted through the transmission media. Examples of non-transitory computer-readable media include a magnetic computer readable medium (e.g., a floppy disk, hard disk, magnetic tape, any other magnetic medium), an optical computer readable medium (e.g., a compact disc read only memory (CD-ROM), a digital versatile disc (DVD), a Blu-Ray disc, or the like), a random access memory (RAM), a programmable read only memory (PROM), an erasable programmable read only memory (EPROM), a FLASH-EPROM, or any other non-transitory medium from which a computer may read. The term computer-readable storage medium is used herein to refer to any computer-readable medium except transmission media. However, it will be appreciated that where embodiments are described to use a computer-readable storage medium, other types of computer-readable mediums may be substituted for or used in addition to the computer-readable storage medium in alternative embodiments.

The terms “client device,” “computing device,” “network device,” “computer,” “user equipment,” and similar terms may be used interchangeably to refer to computer hardware and/or software that is configured to access a service made available by a server (e.g., an operation and escalation management server). The server is often (but not always) on another computer system, in which case the client device accesses the service by way of a network. Client devices may include, without limitation, smart phones, tablet computers, laptop computers, wearables, personal computers, enterprise computers, and the like.

As used herein, the term “circuitry” refers to (a) hardware-only circuit implementations (e.g., implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of “circuitry” applies to all uses of this term herein, including in any claims. As a further example, the term “circuitry” also includes an implementation comprising one or more processors and/or portion(s) thereof and accompanying software and/or firmware. As another example, the term “circuitry” as used herein also includes, for example, a baseband integrated circuit or applications processor integrated circuit for a mobile phone or a similar integrated circuit in a server, a cellular network device, other network device, and/or other computing device.

As used herein, the terms “application,” “software application,” “app,” “product,” “service” or similar terms refer to a computer program or group of computer programs designed to perform coordinated functions, tasks, or activities for the benefit of a user or group of users. A software application may run on a server or group of servers (e.g., a physical or virtual servers in a cloud-based computing environment). In certain embodiments, an application is designed for use by and interaction with one or more local, networked, or remote computing devices, such as, but not limited to, client devices. Non-limiting examples of an application comprise project management, workflow engines, software incident management, team collaboration suites, cloud services, word processors, spreadsheets, accounting applications, web browsers, email clients, media players, file viewers, videogames, audio-video conferencing, and photo/video editors. In various embodiments, an application is a cloud product.

The terms “database,” “resource,” “repository,” and/or similar terms used herein interchangeable may refer to a collection of records or data that is stored in a computer-readable storage medium using one or more database types. The term “database type” may refer to a type of database, such as a hierarchical database, network database, relational database (e.g., Aurora, RDS), entity-relationship database, object database (e.g., S3), document database, semantic database, graph database, noSqL database (e.g., DynamoDB), and/or the like.

As used herein, the term “comprising” means including but not limited to and should be interpreted in the manner it is typically used in the patent context. Use of broader terms such as comprises, includes, and having should be understood to provide support for narrower terms such as consisting of, consisting essentially of, and comprised substantially of.

As used herein, the phrases “in one embodiment,” “according to one embodiment,” “In various embodiments,” and the like generally refer to the fact that the particular feature, structure, or characteristic following the phrase may be included in at least one embodiment of the present disclosure. Thus, the particular feature, structure, or characteristic may be included in more than one embodiment of the present disclosure such that these phrases do not necessarily refer to the same embodiment.

As used herein, the terms “illustrative,” “example,” “exemplary” and the like are used to mean “serving as an example, instance, or illustration” with no indication of quality level. Any implementation described herein as “exemplary”, or “example” is not necessarily to be construed as preferred or advantageous over other implementations.

The terms “about,” “approximately,” “generally,” “substantially,” or the like, when used with a number, may mean that specific number, or alternatively, a range in proximity to the specific number, as understood by persons of skill in the art field and may be used to refer to within manufacturing and/or engineering design tolerances for the corresponding materials and/or elements as would be understood by the person of ordinary skill in the art, unless otherwise indicated.

If the specification states a component or feature “may,” “can,” “could,” “should,” “would,” “preferably,” “possibly,” “typically,” “optionally,” “for example,” “often,” or “might” (or other such language) be included or have a characteristic, that particular component or feature is not required to be included or to have the characteristic. Such component or feature may be optionally included In various embodiments, or it may be excluded.

If the specification presents a list, unless stated otherwise, it is to be understood that each individual element of that list, and every combination of components of that list, is a separate embodiment. For example, “1, 2, 3, 4, and 5” encompasses, among numerous embodiments, 1; 2; 3; 1 and 2; 3 and 5; 1, 3, and 5; and 1, 2, 4, and 5.

The term “plurality”refers to two or more items.

The term “set”refers to a collection of one or more items.

The term “or” is used herein in both the alternative and conjunctive sense, unless otherwise indicated.

### Exemplary Systems, Apparatuses, Methods, and Computer Program Products

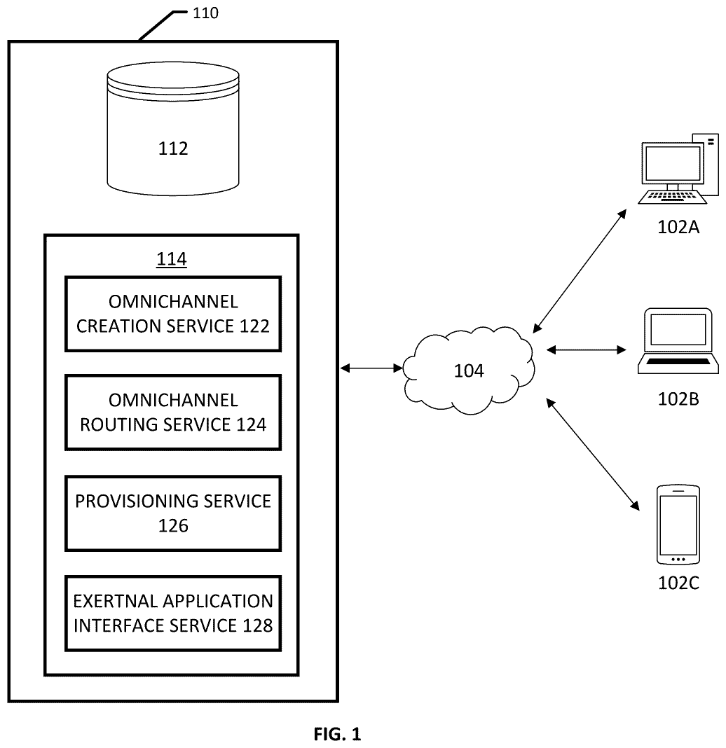

FIG. 1 illustrates an example software management system configured to communicate with client devices in accordance with various example embodiments of the present disclosure. The example system comprises a software management system 110 and a plurality of client devices 102A-102C, each communicatively connected through a network 104. Accordingly, user(s) (e.g., team member, individual contributor, team leader, designer, partners, brands, etc.) may access the software management system 110 via the network 104 using one or more of client devices 102A-102C. The software management system 110 may include a system services 114 in communication with at least one repository, such as the system data repository 112. Such a repository may be hosted by the system services 114 or otherwise hosted by devices in communication with the system services 114. A system services 114 software management system 110 may communicate with one or more client devices 102A-102C via network 104.

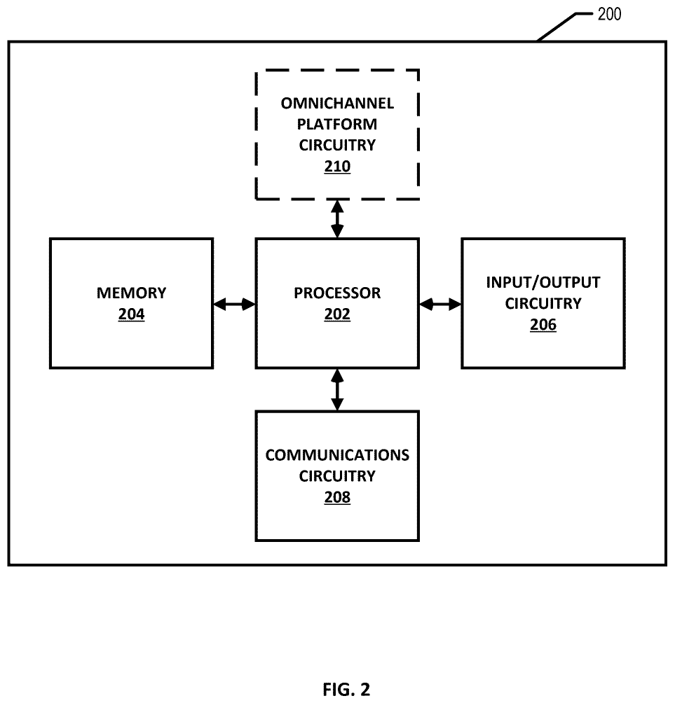

The client device(s) 102A-102C may be a computing device, including as described herein in associated with FIG. 2. A client device 102 may be a mobile device (e.g., smartphone, tablet), which may execute an “app” to interact with the software management system 110, which may be associated with an app channel and thus a channel identifier for an app. Additionally, or alternatively, a client device 102 may interact with the software management system 110 via a web browser, which may be associated with a web browser channel and thus a channel identifier for a web browser. Additionally, or alternatively, a client device 102 may interact with the software management system 110 via email, which may be associated with an email channel and thus a channel identifier for an email. Additionally, or alternatively, a client device 102 may interact with the software management system 110 via a chat function, which may be associated with a chat channel and thus a channel identifier for a chat. In various embodiments, the client device(s) 102A-102C may be configured to display an omnichannel platform interface on a display of the client device for viewing, creating, editing, and/or otherwise interacting with the omnichannel platform, which may be provided by the software management system 110. In various embodiments, an omnichannel platform interface may include an AI agent interface.

A network 104 may include any one or more wired and/or wireless communication networks including, for example, a wired or wireless local area network (LAN), personal area network (PAN), metropolitan area network (MAN), wide area network (WAN), or the like, as well as any hardware, software and/or firmware required for implementing the one or more networks (e.g., network routers, switches, hubs, etc.). For example, network 104 may include a cellular telephone, mobile broadband, long term evolution (LTE), GSM/EDGE, UMTS/HSPA, IEEE 702.11, IEEE 702.16, IEEE 702.20, Wi-Fi, dial-up, and/or WiMAX network. Furthermore, the network 104 may include a public network, such as the Internet, a private network, such as an intranet, or combinations thereof, and may utilize a variety of networking protocols now available or later developed including, but not limited to TCP/IP based networking protocols. For instance, the networking protocol may be customized to suit the needs of the software management system 110.

A system services 114 may include circuitry, networked processors, or the like configured to perform some or all of the operations and/or processes described herein. In various embodiments, system services 114 may determine and transmit commands and instructions to client devices 102A-102C, using data from, for example, the system data repository 112. In this regard, the system services 114 may be embodied by computing device, such as described herein in association with FIG. 2. In various embodiments, system services 114 may be located remotely from the system data repository 112, although in other embodiments, the system services 114 may comprise the system data repository 112. The system services 114 may, in various embodiments, comprise several servers or computing devices performing interconnected and/or distributed functions.

The systems services 114 may include an omnichannel creation service 122, an omnichannel routing service 124, a provisioning service 126, and an external application interface service 128. Each of the system service 114 may call on or interact with one or more other of the system services 114. An omnichannel creation service 122 may receive a user experience omnichannel generation request and generate a user experience omnichannel configuration data object. An omnichannel routing service 124 may retrieve a user experience omnichannel configuration data object stored in a user experience omnichannel configuration database and route a request data object according to one or more data in the user experience omnichannel configuration data object, such as the identifiers described herein. A provisioning service 126 provides for setting or providing one or more permissions described herein, such as one or more permissions for a leader user account, an agent account, and/or an experience user account. An external application interface service 128 interfaces and/or communicates with external applications to receive and/or transmit data objects, such as request data objects. The external application interface service 128 may communicate with other system services 114.

The system data repository 112 may be stored by any suitable storage device configured to store some or all of the information described herein (e.g., memory, one or more databases, backend data servers, network databases, cloud storage devices, or the like provided by another device (e.g., online application or 3^{rd} party provider), such as a Network Attached Storage (NAS) device or devices, or as a separate database server or servers).

The system data repository 112 includes data accessed and stored by the system services 114 to facilitate the software management system 110. As such, the system data repository 112 may include, for example, the experience definition configuration database, project templates, project parameters, omnichannel parameters, channel parameters, project template selection indications, user experience omnichannel configuration data objects, and/or the like. In various embodiments, the system data repository may be one or more AI agent sources.

In various embodiments, the system data repository 112 stores the experience configuration database. Thus, the experience definition configuration database in the system data repository 112 is accessed for a plurality of project templates associated with the user experience omnichannel configuration data object. Once the user experience omnichannel configuration data object is updated based on the one or more project template selection indications that was received from the user experience omnichannel configuration database, the user experience omnichannel configuration data object is transmitted to the user experience omnichannel configuration database for storage in the system data repository 112.

FIG. 2 illustrates a block diagram of an example computing device in accordance with various example embodiments of the present disclosure. In various embodiments, the software management system 110 may include the components of the computing device 200. In various embodiments, a client device 102 may include various components of the computing device 200.

A computing device 200 may include a processor 202, memory 204, input/output circuitry 206, communications circuitry 208, and/or omnichannel platform circuitry 210, which may allow the computing device 200 to execute and perform some or all of the operations described herein.

In various embodiments, omnichannel platform circuitry 210 is included in computing device 200, the omnichannel platform circuitry 210 configured to facilitate the functionality and/or operations described herein regarding generating a user experience omnichannel configuration data object, an experience definition configuration database, project templates, project parameters, omnichannel parameters, channel parameters, project template selection indications, project identifiers, channel identifiers, issue identifiers, routing identifiers, request data objects, and request issue identifiers and/or the like.

The processor 202 (and/or co-processor or any other processing circuitry assisting or otherwise associated with the processor) may be in communication with the memory 204 via a bus for passing information among components of the computing device 200. The memory 204 is non-transitory and may include, for example, one or more volatile and/or non-volatile memories, or some combination thereof. The memory 204 may be an electronic storage device (e.g., a computer readable storage medium). The memory 204 may be configured to store information, data, content, applications, instructions, or the like, for enabling a system or apparatus (e.g., software management system 110) to carry out various functions and/or operations in accordance with the present disclosure.

Processor 202 may be embodied in a number of different ways and may, for example, include one or more processing devices configured to perform independently. Additionally, or alternatively, processor 202 may include one or more processors configured in tandem via a bus to enable independent execution of instructions, pipelining, and/or multithreading. Processor 202 may, for example, be embodied as various means including one or more microprocessors with accompanying digital signal processor(s), one or more processor(s) without an accompanying digital signal processor, one or more coprocessors, one or more multi-core processors, one or more controllers, processing circuitry, one or more computers, various other processing elements including integrated circuits such as, for example, an ASIC (application specific integrated circuit) or FPGA (field programmable gate array), or some combination thereof. The use of the term “processing circuitry” may be understood to include a single core processor, a multi-core processor, multiple processors internal to the apparatus, and/or remote or “cloud” processors. Accordingly, although illustrated in FIG. 2 as a single processor, in various embodiments, processor 202 comprises a plurality of processors. The plurality of processors may be embodied on a single computing device or may be distributed across a plurality of such devices collectively configured to function as computing device 200. The plurality of processors may be in operative communication with each other and may be collectively configured to perform one or more functionalities of computing device 200 as described herein.

In an example embodiment, processor 202 is configured to execute instructions stored in the memory 204 or otherwise accessible to processor 202. Alternatively, or additionally, the processor 202 may be configured to execute hard-coded functionality. As such, whether configured by hardware or software methods, or by a combination thereof, the processor 202 may represent an entity (e.g., physically embodied in circuitry) capable of performing operations according to an embodiment of the present disclosure while configured accordingly. Alternatively, as another example, when the processor 202 is embodied as an executor of software instructions, the instructions may specifically configure processor 202 to perform one or more algorithms and/or operations described herein when the instructions are executed. For example, these instructions, when executed by processor 202, may cause computing device 200 to perform one or more of the functionalities of computing device 200 as described herein.

Memory 204, although illustrated in FIG. 2 as a single memory, may comprise a plurality of memory components. The plurality of memory components may be embodied on a single computing device or distributed across a plurality of computing devices. In various embodiments, memory 204 may comprise, for example, a hard disk, random access memory, cache memory, flash memory, a compact disc read only memory (CD-ROM), digital versatile disc read only memory (DVD-ROM), an optical disc, circuitry configured to store information, or some combination thereof. Memory 204 may be configured to store information, data, applications, instructions, or the like for enabling computing device 200 to carry out various functions in accordance with example embodiments discussed herein. For example, in at least some embodiments, memory 204 is configured to buffer data for processing by processor 202. Additionally, or alternatively, in at least some embodiments, memory 204 is configured to store program instructions for execution by processor 202. Memory 204 may store information in the form of static and/or dynamic information. This stored information may be stored and/or used by computing device 200 during the course of performing its functionalities.

The input/output circuitry 206 may be in communication with processor 202 to provide an audible, visual, mechanical, or other output and/or, in various embodiments, to receive an indication of an input. In that sense, input/output circuitry 206 may include means for performing analog-to-digital and/or digital-to-analog data conversions. Input/output circuitry 206 may include support, for example, for a display, touchscreen, keyboard, button, click wheel, mouse, joystick, an image capturing device (e.g., a camera), motion sensor (e.g., accelerometer and/or gyroscope), microphone, audio recorder, speaker, biometric scanner, and/or other input/output mechanisms. Input/output circuitry 206 may comprise a user interface, web user interface, a mobile application, a kiosk, or the like. The processor 202 and/or user interface circuitry comprising the processor 202 may be configured to control one or more functions of a display or one or more user interface elements through computer program instructions (e.g., software and/or firmware) stored on a memory accessible to the processor 202 (e.g., memory 204, and/or the like). In various embodiments, aspects of input/output circuitry 206 in computing device 200 may be reduced when implemented also or instead as an end-user machine or other type of device designed for complex user interactions (i.e., client device 102A-102C). In some embodiments (like other components discussed herein), input/output circuitry 206 may even be eliminated from computing device 200. Alternatively, at least some aspects of input/output circuitry 206 may be embodied on an apparatus used by a user (e.g., a team member, an individual contributor, a network environment user, and/or the like) that is in communication with the computing device 200. Input/output circuitry 206 may be in communication with memory 204, communications circuitry 208, and/or any other component(s), such as via a bus. Although more than one input/output circuitry and/or other component may be included in computing device 200, only one is shown in FIG. 2 to avoid overcomplicating the disclosure (e.g., like the other components discussed herein).

Communications circuitry 208 may be any means such as a device or circuitry embodied in either hardware or a combination of hardware and software that is configured to receive and/or transmit data from/to a network and/or any other device, circuitry, or module in communication with computing device 200. In this regard, the communications circuitry 208 may include, for example, a network interface for enabling communications with a wired or wireless communication network. Communications circuitry 208 may be configured to receive and/or transmit any data that may be stored by memory 204 using any protocol that may be used for communications between computing devices. For example, the communications circuitry 208 may include one or more network interface cards, antennae, transmitters, receivers, buses, switches, routers, modems, and supporting hardware and/or software, and/or firmware/software, or any other device suitable for enabling communications via a network. Additionally, or alternatively, the communication interface may include the circuitry for interacting with the antenna(s) to cause transmission of signals via the antenna(s) or to handle receipt of signals received via the antenna(s). These signals may be transmitted by computing device 200 using any of a number of wireless personal area network (PAN) technologies, such as Bluetooth® v1.0 through v3.0, Bluetooth Low Energy (BLE), infrared wireless (e.g., IrDA), ultra-wideband (UWB), induction wireless transmission, or the like. In addition, it should be understood that these signals may be transmitted using Wi-Fi, Near Field Communications (NFC), Worldwide Interoperability for Microwave Access (WiMAX) or other proximity-based communications protocols. Communications circuitry 208 may additionally or alternatively be in communication with the memory 204, input/output circuitry 206 and/or any other component of computing device 200, such as via a bus.

In various embodiments, omnichannel platform circuitry 210 may also be included and configured to perform the functionality described herein related to providing user experience omnichannel configuration data objects, experience definition configuration databases, project templates, project parameters, omnichannel parameters, channel parameters, project template selection indications, project identifiers, channel identifiers, issue identifiers, routing identifiers, request data objects, and request issue identifiers and/or the like. Omnichannel platform circuitry 210 includes hardware components and/or software configured to support interface component functionality, features, and/or services of the computing device 200. The omnichannel platform circuitry 210 may utilize processing circuitry, such as the processor 202, to perform its corresponding operations, and may utilize memory 204 to store collected information. The omnichannel platform circuitry 210 may send and/or receive data from system data repository 112. In some implementations, the sent and/or received data may include user experience omnichannel configuration data objects, experience definition configuration databases, project templates, project parameters, omnichannel parameters, channel parameters, project template selection indications, project identifiers, channel identifiers, issue identifiers, routing identifiers, request data objects, and request issue identifiers and/or the like. In various embodiments, the omnichannel platform circuitry 210 may include hardware components and/or software configured to support AI agent functionality as described herein.

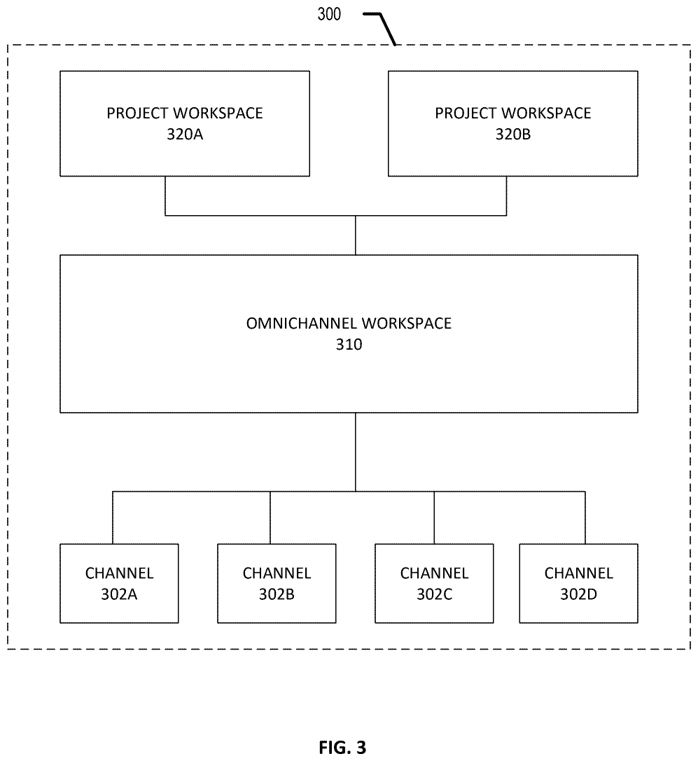

FIG. 3 illustrates a block diagram schematic of a first omnichannel configuration example of a user experience omnichannel configuration data object in accordance with various example embodiments of the present disclosure. The omnichannel configuration, once generated by an omnichannel generation service 122, is stored in a user experience omnichannel configuration data object that is used by the omnichannel routing service 124 to route one or more request data objects according to the omnichannel configuration. The first example of an omnichannel configuration 300 includes one or more channels 302 (e.g., 302A-302D), an omnichannel workspace 310, and one or more project workspaces 320 (e.g., 320A-320B).

In various embodiments, the software management system 110 receives a user experience omnichannel generation request from a client device 102 associated with a leader user account. The leader may desire to create an omnichannel configuration for responding to requests received. In response to receiving the user experience omnichannel generation request, the software management system 110 generates a user experience omnichannel configuration data object within the omnichannel configuration 300.

In various embodiments, the channels 302A-302D are associated with the at least one channel parameter. In various embodiments, the channel parameter is associated with a plurality of project templates. In various embodiments, the channel parameter is associated with the user experience omnichannel configuration data object. In some embodiments the software management system 110 receives from the first computing device associated with the first leader user, project template selection indications. In various embodiments, the project selection indications identify a selected project template of the plurality of project templates and may identify at least one channel parameter. In various embodiments, the user experience omnichannel configuration data object is updated to reflect the project template selection indications and therefore at least one channel parameter. In various embodiments, the channel parameter includes at least one of a channel identifier, a priority identifier, and a request template identifier.

In various embodiments, the omnichannel workspace 310 is associated with the at least one omnichannel parameter which includes at least one experience user permission identifier, brand identifier, service identifier, knowledge base identifier, and/or AI agent identifier. The inclusion of one or more of these identifiers may be associated with a configuration of the user experience omnichannel configuration data object generated in response to the user experience omnichannel generation request by the first computing device associated with a leader user account.

The project workspace 320A and project workspace 320B correspond to a first selected project template and a second selected project template. The first selected project template is associated with at least one project parameter which includes at least one of a first issue type identifier and a first agent account permission identifier. The second selected project template is associated with at least one project parameter which includes at least one of a second issue type identifier and a second agent account permission identifier.

In an example of using an omnichannel configuration 300, the software management system 110 receives a first request data object associated with a request issue identifier via a first channel being one of 302A-302D. The first channel is associated with the first channel identifier and the request issue identifier is the first issue identifier. The software management system 110 accesses the user experience omnichannel configuration data object within the omnichannel workspace 310. Within the omnichannel workspace 310, the routing identifier, the channel identifier, and the issue identifier of the request data object are determined based on the user experience omnichannel configuration data object. The request data object is routed to the project based on the routing identifier of the selected project template within the project workspace 320A-320B wherein the selected project template within the project workspace 320A and 320B has a channel parameter identical to the channel parameter associated with the first request data object.

In another example, a second computing device associated with an experience user account transmits a request data object. The omnichannel apparatus receives, via a channel 302A, the request data object, associated with a request issue identifier. Within the omnichannel workspace 310, the user experience omnichannel configuration database is accessed, and the channel identifier and the request issue identifier of the request data object are determined. The request data object is routed to a project workspace 320 based on the routing identifier of the selected project template within the project workspace 320A. The project workspace 320 is associated with a project parameter which includes at least an issue type identifier and an agent account permission identifier. Thus an agent with an agent account having permissions to access the project workspace 320 may receive the request data object and being to address the request in the request data object.

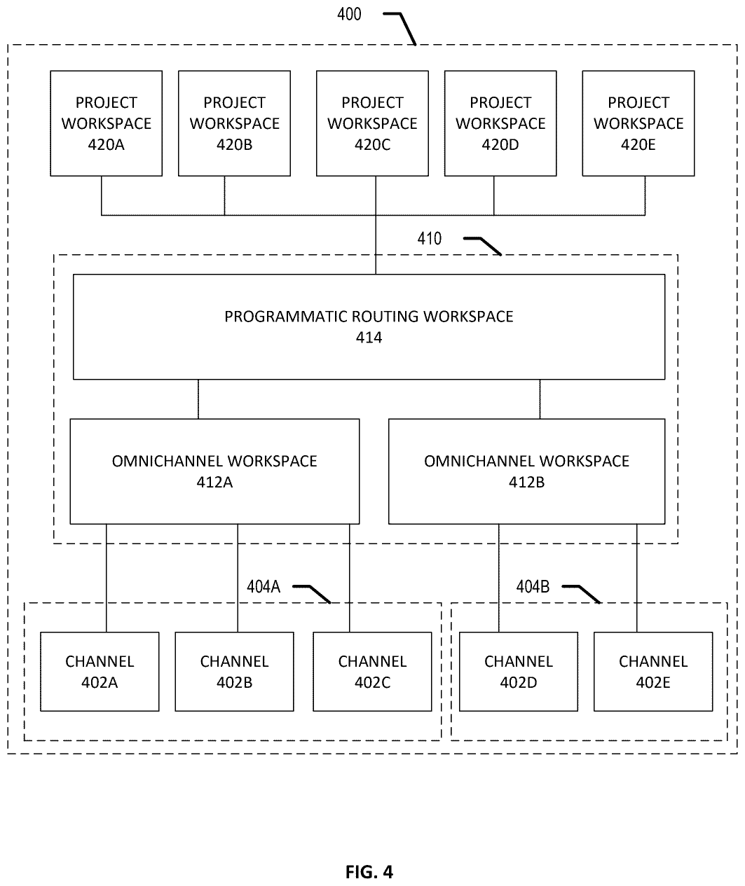

FIG. 4 illustrates a block diagram schematic of a second omnichannel configuration example of a user experience omnichannel configuration data object in accordance with various example embodiments of the present disclosure. The omnichannel configuration, once generated by an omnichannel generation service 122, is stored in a user experience omnichannel configuration data object that is used by the omnichannel routing service 124 to route one or more request data objects according to the omnichannel configuration. The omnichannel configuration 400 comprises a first channel group 404A comprising channels 402A-402C and a second channel group 404B comprising channels 404D and 404E. An omnichannel platform 410 includes a first omnichannel workspace 412A and a second omnichannel workspace 412B and a programmatic routing workspace 414. In various embodiments, omnichannel configuration 400 also includes project workspaces 420A-420E.

A channel group 404 may include multiple channels associated with a particular experience user and/or type of experience user. For example, an experience user may reach out with a request via an email with a first channel 402A, via a text with a second channel, or via a web portal with a third channel 402C. Each of these channels may be specific to the experience user or type of experience user(s). For example, a first channel group 404A may be associated with a specific company while a second channel group 404B may be associated with the general public.

Each omnichannel workspace 412 may be associated with different permissions. The first omnichannel workspace 412A may be associated with the first channel group 404A. The first omnichannel workspace 412A may provide access via permissions associated with the first channel group to one or more of the project workspaces 420. The second omnichannel workspace 412B may be associated with the second channel group 404B. The second omnichannel workspace 412A may provide access via permissions associated with the second channel group to one or more of the project workspaces 420, which may be more of fewer of the project workspaces than associated with the first channel group 404A.

Each omnichannel workspace 412 may also be associated with different brands, service catalogues, knowledge repositories, AI agents, and the like. Such difference may be associated with how a request data object is routed and/or responded to. For example, two different brands may have different branding associated with responding to request data object.

A programmatic routing workspace 414 may be a programmatic routing layer that may be associated with one or more routing operations that that may programmatically evaluate a request data object before it is programmatically routed to a project workspace 420 based on one or more characteristics determined by the programmatic evaluation. At the programmatic routing workspace 414, it may be evaluated if a request data object includes one or more data that may be used to determine one or more project workspaces 420A-E for the request data object to be routed to allow for the respective project workspace to address and respond to the request. In various embodiments, the programmatic routing may be set up and/or preset to route a request data object based one or more data with a persistent form of routing. Alternatively, or additionally, the programmatic routing may be based on machine learning to provide for dynamic routing of request data objects.

In various embodiments, one or more project workspaces 420 or a programmatic routing workspace 414 may include an AI agent. The AI agent may be associated with an AI agent identifier that may route a request data object to the AI agent. The AI agent, having received the request data object, may generate an AI agent request data object based at least on the request data object. To generate the AI agent request data object one or more additional data may be added, such as from an AI agent source. The AI agent request data object may be generated by formatting a request data object, which may include formatting a request in the request data object into a format that may be used by a large language model, as well as adding additional data from an AI agent source. For example, this may include parsing a request received, translating a request, re-wording a request received, adding data associated with one or more portions of the parsed, translated, and/or re-worded request. In various embodiments, the AI agent source may add or include data stored in the system data repository 112 to generate the AI agent request data object, such as to add data associated with a request. The AI agent request data object may include a generative model prompt that is provided to a large language model. The AI agent may provide the AI agent request data object to a large language model. The AI agent may then receive, from the large language model and in response to the AI agent request data object, an AI agent response data object. For example, in various embodiments the AI agent request data object may include a data received from an AI agent source and a generative model prompt generated by the AI agent that is provided to a large language model. In response, the large language model may generate an AI agent response data object that includes a response generated based on the generative model prompt and the data provided to the large language model. The AI agent response data object may include a response that is provided to an experience user account in response to request received from the experience user account via the omnichannel configuration 400. In various embodiments, providing a response to an experience user account may be via an AI agent interface that the experience account user may use to interface with the AI agent.

In various embodiments, to generate the omnichannel configuration 400, a first computing device associated with a first leader user account, receives a user generation request. In various embodiments, in response to receipt of the first user experience omnichannel generation request, a user experience omnichannel configuration data object is generated. The user experience omnichannel configuration data object will store the omnichannel configuration that will allow for routing and addressing a help data request. In various embodiments, an experience definition configuration database is accessed for a plurality of project templates associated with the user experience omnichannel configuration data object. In various embodiments, each project template of the plurality of project templates is associated with one or more project parameters, one or more omnichannel parameters, and one or more channel parameters. In various embodiments, the at least one project parameter includes a first project identifier, the at least one channel parameter includes a first channel identifier and a first issue identifier, the at least one omnichannel parameter includes a first routing identifier, and the routing identifier associates the first channel identifier and first issue identifier with the first project identifier. In various embodiments, the software management system 110 receives, from the first computing device, one or more project template selection indications. In various embodiments, the project template selection indications correspond to the project workspaces 420A-420E within the omnichannel configuration 400. In various embodiments, each project template selection indication identifies a selected project template of the plurality of project templates and identifies at least one project parameter, at least one omnichannel parameter, and at least one channel parameter. In various embodiments, the at least one omnichannel parameter determines the structure of the omnichannel platform 410, specifically the generation of the programmatic routing workspace 414 and omnichannel workspaces 412A and 412B and is thus associated with at least one of an experience user permission identifier, brand identifier, service identifier, and knowledge base identifier. In various embodiments, the at least one channel parameter is indicative of the channels 402A-402E and is thus associated with at least one of a channel identifier, a priority identifier, and a request template identifier.

In an example of accessing the omnichannel configuration 400, the software management system 110 may receive, from a second computing device associated with an experience user account, a first request data object associated with a request issue identifier via a first channel. In various embodiments, the first channel is associated with the first channel identifier and the request issue identifier is the first issue identifier. In various embodiments, the user experience omnichannel configuration data object, which contains the omnichannel configuration 400, is then accessed from the user experience omnichannel configuration database. In various embodiments, the first routing identifier is determined based on the user experience omnichannel configuration data object and the first channel identifier and the first issue identifier of the first request data object and the first request data object is routed to a first project workspace 420A based on the first routing identifier of the first selected project template.

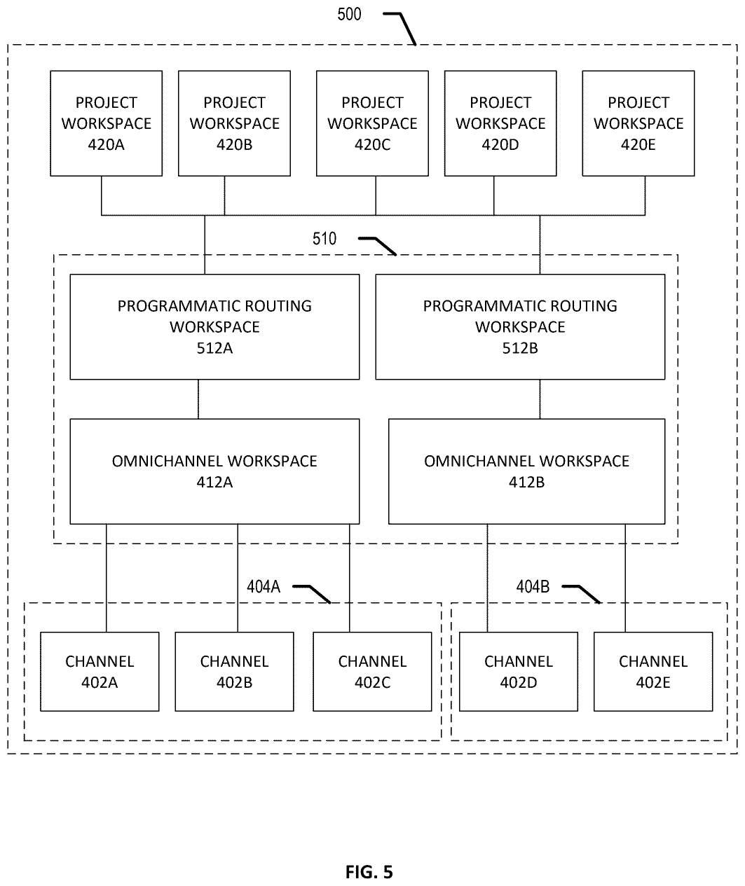

FIG. 5 illustrates a block diagram schematic of a third omnichannel configuration example of a user experience omnichannel configuration data object in accordance with various example embodiments of the present disclosure. The omnichannel configuration, once generated by an omnichannel generation service 122, is stored in a user experience omnichannel configuration data object that is used by the omnichannel routing service 124 to route one or more request data objects according to the omnichannel configuration. The omnichannel configuration 500 is a variation of the omnichannel configuration 400. In omnichannel configuration 500 there are more than one programmatic routing workspace. For example, in omnichannel configuration 500 there is a first programmatic routing workspace 512A and a second programmatic routing workspace 512B. Each programmatic routing workspace 512 is uniquely associated with an omnichannel workspace 412 (e.g., 512A with 412A, 512B with 412B). In such an embodiment, a programmatic routing workspace may be associated with one or more aspects of the of a channel group (e.g., 512A with 404A, etc.).

In various embodiments, to generate the omnichannel configuration 500, a first computing device associated with a first leader user account, receives a user generation request. In various embodiments, in response to receipt of the first user experience omnichannel generation request, a user experience omnichannel configuration data object is generated. In various embodiments, an experience definition configuration database is accessed for a plurality of project templates associated with the user experience omnichannel configuration data object. In various embodiments, each project template of the plurality of project templates is associated with one or more project parameters, one or more omnichannel parameters, and one or more channel parameters. In various embodiments, the at least one project parameter includes a first project identifier, the at least one channel parameter includes a first channel identifier and a first issue identifier, the at least one omnichannel parameter includes a first routing identifier, and the routing identifier associates the first channel identifier and first issue identifier with the first project identifier. In various embodiments, the software management system 110 receives, from the first computing device, one or more project template selection indications. In various embodiments, the project template selection indications correspond to the project workspaces 420A-420E within the omnichannel configuration 500. In various embodiments, each project template selection indication identifies a selected project template of the plurality of project templates and identifies at least one project parameter, at least one omnichannel parameter, and at least one channel parameter. In various embodiments, the at least one omnichannel parameter determines the structure of the omnichannel platform 510, specifically the generation of the programmatic routing workspaces 512A and 512B and the omnichannel workspaces 412A and 412B and is thus associated with at least one of an experience user permission identifier, brand identifier, service identifier, and knowledge base identifier. In various embodiments, the at least one channel parameter is indicative of the channels 402A-402E and is thus associated with at least one of a channel identifier, a priority identifier, and a request template identifier.

To access the omnichannel configuration 500, the software management system 110 may receive, from a second computing device associated with an experience user account, a first request data object associated with a request issue identifier via a first channel. In various embodiments, the first channel is associated with the first channel identifier and the request issue identifier is the first issue identifier. In various embodiments, the user experience omnichannel configuration data object, which contains the omnichannel configuration 500, is then accessed from the user experience omnichannel configuration database. In various embodiments, the first routing identifier is determined based on the user experience omnichannel configuration data object and the first channel identifier and the first issue identifier of the first request data object and the first request data object is routed to a first project based on the first routing identifier of the first selected project template.

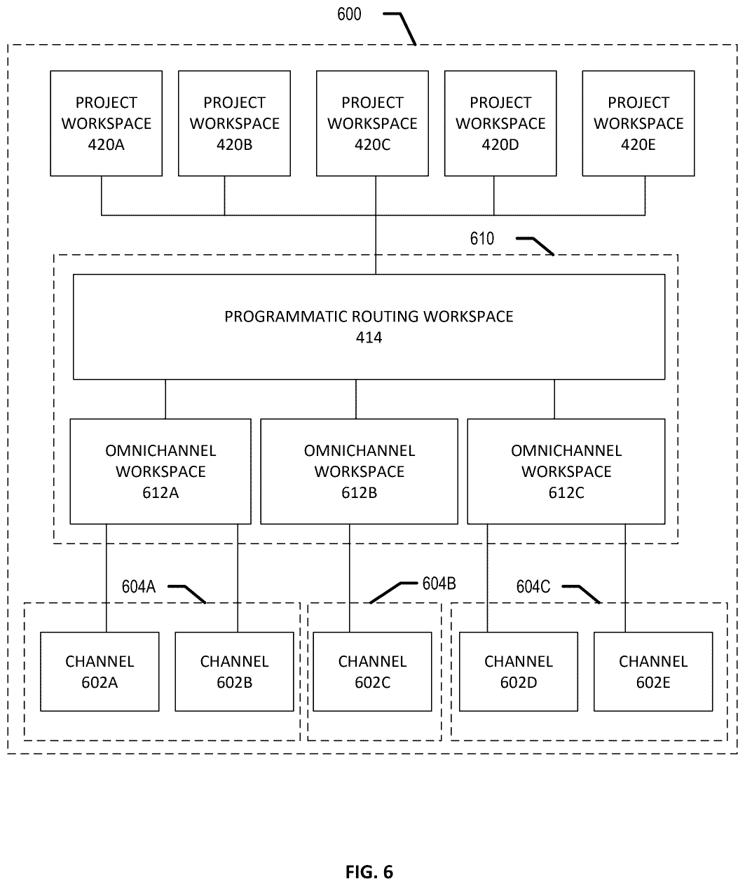

FIG. 6 illustrates a block diagram schematic of a fourth omnichannel configuration example of a user experience omnichannel configuration data object in accordance with various example embodiments of the present disclosure. The omnichannel configuration, once generated by an omnichannel generation service 122, is stored in a user experience omnichannel configuration data object that is used by the omnichannel routing service 124 to route one or more request data objects according to the omnichannel configuration. The omnichannel configuration 600 comprises channel group 604A, channel group 604B, and channel group 604C. In various embodiments, channel group 604 comprises channel 602A and channel 602B. In various embodiments, channel group 604B comprises channel 602C. In various embodiments, channel group 604C comprises channel 602D and channel 602E. In various embodiments, omnichannel platform 610 comprises programmatic routing workspace 414 which is associated with omnichannel workspace 612A, 612B, and 612C. In various embodiments, omnichannel workspace 612A is associated with channel group 604A and further associated with channel 602A and channel 602B. In various embodiments, omnichannel workspace 612B is associated with channel group 604B and is further associated with channel 602C. In various embodiments, omnichannel workspace 612C is associated with channel group 604C and further associated with channel 602D and channel 602E. In various embodiments, the omnichannel configuration 600 comprises project workspace 420A, project workspace 420B, project workspace 420C, project workspace 420D, and project workspace 420E. In various embodiments, project workspace 420A-420E is associated with omnichannel platform 610 and is further associated with programmatic routing workspace 414. Thus, the omnichannel configuration 600 is a variation of the omnichannel configuration 400. In omnichannel configuration 600 there are more than two omnichannel workspaces 612 with each omnichannel workspace 612 being associated with a different channel group 604.

In various embodiments, to generate the omnichannel configuration 600, a first computing device associated with a first leader user account, receives a user generation request. In various embodiments, in response to receipt of the first user experience omnichannel generation request, a user experience omnichannel configuration data object is generated. In various embodiments, an experience definition configuration database is accessed for a plurality of project templates associated with the user experience omnichannel configuration data object. In various embodiments, each project template of the plurality of project templates is associated with one or more project parameters, one or more omnichannel parameters, and one or more channel parameters. In various embodiments, the at least one project parameter includes a first project identifier, the at least one channel parameter includes a first channel identifier and a first issue identifier, the at least one omnichannel parameter includes a first routing identifier, and the routing identifier associates the first channel identifier and first issue identifier with the first project identifier. In various embodiments, the software management system 110 receives, from the first computing device, one or more project template selection indications. In various embodiments, the project template selection indications correspond to the project workspaces 420A-420E within the omnichannel configuration 600. In various embodiments, each project template selection indication identifies a selected project template of the plurality of project templates and identifies at least one project parameter, at least one omnichannel parameter, and at least one channel parameter. In various embodiments, the at least one omnichannel parameter determines the structure of the omnichannel platform 610, specifically the generation of the programmatic routing workspaces 414 and the omnichannel workspaces 612A-612C and is thus associated with at least one of an experience user permission identifiers, brand identifier, service identifier, and knowledge base identifier. In various embodiments, the at least one channel parameter is indicative of the channels 602A-602E and is thus associated with at least one of a channel identifier, a priority identifier, and a request template identifier.

To access the omnichannel configuration 600, the software management system 110 may receive, from a second computing device associated with an experience user account, a first request data object associated with a request issue identifier via a first channel. In various embodiments, the first channel is associated with the first channel identifier and the request issue identifier is the first issue identifier. In various embodiments, the user experience omnichannel configuration data object, which contains the omnichannel configuration 600, is then accessed from the user experience omnichannel configuration database. In various embodiments, the first routing identifier is determined based on the user experience omnichannel configuration data object and the first channel identifier and the first issue identifier of the first request data object and the first request data object is routed to a first project based on the first routing identifier of the first selected project template.

Example processes and/or operations of the disclosure will now be discussed with flowcharts. It will be appreciated that each of the flowcharts descries a methods and/or an example computer-implemented process that is performable by one or more of the apparatuses, systems, devices, and/or computer program products described herein.

The blocks indicate operations of each process. Such operations may be performed in any of a number of ways, including, without limitation, in the order and manner as depicted and described herein. In various embodiments, one or more blocks of any of the processes described herein occur in-between one or more blocks of another process, before one or more blocks of another process, in parallel with one or more blocks of another process, and/or as a sub-process of a second process. Additionally, or alternatively, any of the processes in various embodiments include some or all operational steps described and/or depicted, including one or more optional blocks in some embodiments. With regard to the flowcharts illustrated herein, one or more of the depicted block(s) in some embodiments is/are optional in some, or all, embodiments of the disclosure. Similarly, it should be appreciated that one or more of the operations of each flowchart may be combinable, replaceable, and/or otherwise altered as described herein.

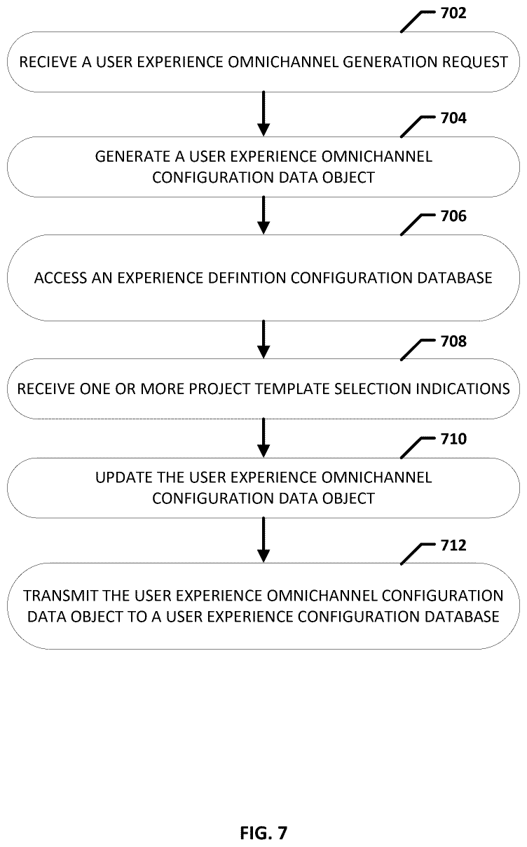

FIG. 7 illustrates a flowchart of operations associated with generating a user experience omnichannel configuration data object in accordance with one or more embodiments of the present disclosure. One or more operations described in FIG. 7 may be performed by the omnichannel creation service 122, which may be in conjunction with utilizing one or more other of the system services 114.

At operation 702, receive a user experience omnichannel generation request. In various embodiments, a user experience omnichannel generation request is received from a first leader user account associated with a first computing device. The user experience omnichannel generation request is received by the software management system 110 and is associated with a request to generate a user experience omnichannel configuration data object that will include an omnichannel configuration (e.g., 300). The user experience omnichannel generation request may be received through the external application interface service 128.

In various embodiments, the user experience omnichannel generation request may include one or more data associated with how to configure the user experience omnichannel configuration data object and, thus, the omnichannel configuration (e.g., 300).

At operation 704, generate a user experience omnichannel configuration data object based at least in part on the user experience omnichannel generation request. The software management system 110, including the system data repository 112 and the system services 114, generate the user experience omnichannel configuration data object on the software management system 110.

At operation 706, access an experience definition configuration database. The software management system 110 may, in response to or in association with, generating the user experience omnichannel configuration data object, request to access and access an experience definition configuration database. The experience definition configuration database may include a plurality of project templates. The first leader user account via the associated computing device may also receive access to the experience definition configuration database and be presented with a selection of the plurality of project templates to select from. In this regard, for example, the computing device 200 may access, through the software management system 110, a plurality of project templates associated with the user experience omnichannel configuration data object. In some embodiments the plurality of project templates that are associated with the experience definition configuration database are stored on the system data repository 112 associated with the software management system 110. Each of the project templates from the plurality of project templates in the experience definition configuration database is associated with one or more project parameters, one or more omnichannel parameters, and one or more channel parameters. The project parameter includes at least one of a first issue type identifier and a first agent account permission identifier. The omnichannel parameter includes at least one of an experience user permission identifier, brand identifier, service identifier, and knowledge base identifier. The channel parameter includes at least one of an experience user permission identifiers, brand identifier, service identifier, and knowledge base identifier. The permission identifiers may be received or coordinated via the provisioning service 126.

In various embodiments, each of these identifiers may be subsequently configured after the user experience omnichannel configuration data object has been stored in a user experience omnichannel configuration database of the system data repository.

At operation 708, receive one or more project template selection indications. For example, via the first client device 102 associated with a first leader user account, the leader identifies the project template selections, which generates project template selection indications that are transmitted to the software management system 110. The software management system 110 then receives the project template selection indications. Each project template selection indication identifies a selected project template of the plurality of project templates available in the experience definition configuration database. The project template selection is also associated with the identification of at least one project parameter, at least one omnichannel parameter, and at least one channel parameter.

At operation 710, update the user experience omnichannel configuration data object. The user experience omnichannel configuration data object was previously created and is now being updated with user selected project templates. The project template selections are made by way of project template selection indications which include at least one project parameter, at least one omnichannel parameter, and at least one channel parameter. The user experience omnichannel configuration data object is updated to include the project template selection indications and thus the at least one project parameter, at least one omnichannel parameter, and the at least one channel parameter is included in the updated user experience omnichannel configuration data. Thus, via the project templates the omnichannel configuration (e.g., 300) is being specified for how, for example, a request data object may be routed to a project workspace.

At operation 712, transmit the user experience omnichannel configuration data object to a user experience omnichannel configuration database. The user experience omnichannel configuration data object, having been updated, is stored for later use when a request data object is received.

In various embodiments, the omnichannel creation service 122 may include an omnichannel creation service interface that is rendered on a display and allows for a user (e.g., first leader user account) to provide various data used in generating the experience omnichannel generation request, which is then used to general the user experience omnichannel configuration data object. For example, an omnichannel creation service interface may allow for data that may be used to generate the user experience omnichannel configuration data object. In various embodiments, this data may include, but is not limited to, a user to input data for specifying, configuration, or selecting forms, articles, AI agents, branding, channels, and customer access.

In various embodiments, a user account having the appropriate permissions, such as a leader user account, may update the user experience omnichannel configuration data object again. This may allow for a leader user account to specify or configure one or more identifiers associated with one or more portions of an omnichannel configuration (e.g., 300, 400, 500, 600).

In various embodiments, configuration may include configuring channel groups such that response to a first channel group may be different from responses to a second channel group. For example a first channel group may be associated with an email channel and a second channel group may also be associated with an email channel. Configuration may including turning on or off one of these channels, selecting how an email may generate or format a request data object, configure one or more identifiers associated with a channel identifier and/or an email address.

In another example, a first channel group may be associated with a first web portal and a second channel group may be associated second web portal. Configuration may include identifying one or more URLs, applying a brand to a URL or webpage to change the look and/or feel of the webpage presented to an experience user account generating a request data object and/or an agent account addressing a request data object, identifying a specific template to be used for the channel for generating a request data object from each web portal, and the like.

In another example, configuration may include configuring a channel or channel groups such that a first channel or channel group may access a first knowledge base and a second channel or channel group may access a second knowledge base. Each knowledge base may be different, such as based on the sophistication of an experience user account, which may be associated with one or more account permissions. A configuration may also include which accounts, if any, may update or revise a knowledge base.

In another example, a first channel group may be associated with a first AI agent and a second channel group may be associated with a second AI agent. Configuration may include identifying an AI agent by an AI agent identifier for each channel group along with one or more AI agent sources for each channel group. The AI agent may also be configured with or to apply one or more brands to change the look and/or feel of an AI agent response data object that may be provided to a user in response to a request data object.

In another example, configurations may include how responses to request data objects may be generated and transmitted to an experience user account. For example, a configuration may provide for when to generate and send an experience user notification (e.g., emails, text messages). It may also include branding to utilize for an experience user notification, such as via a branding template that may be used when generating an experience user notification.

In another example, configuration may include configuring how a request data object may be routed, including by analyzing one or more request data in the request data object. For example, the request data may indicate if the request data object is easily resolved and may be routed to a programmatic routing workspace 414 of if a request data object might pass through a programmatic routing workspace to proceed to a project workspace 420.

In another example, configurations may include generating an automation for determining a number of help request objects in one or more queues (e.g., with a first project workspace 420A) and then re-route a new help request object to a different queue that may be shorter (e.g., with a second project workspace 420B). This may be based on a queue containing a number of request data objects that exceed a threshold.

In another example, configurations may include one or more data to add to or append to a request data object. For example, based on a channel 402 through which a request data object is received, such as a channel 402 associated with a channel group 404, one or more data may be added or appended to the request data object. This added or appended data may, for example, identify an experience user, experience user context, organization, products, or other data associated with the channel 402 and/or channel group 404.

In another example, configurations, may include allowing a project workspace to see a queue or request data objects associated with another project workspace.

In another example, configurations, may include allowing a project workspace to create another request data object on behalf of a user experience account based on an original request data object received.

In another example, configurations, may include splitting an original request data object received into two or more request data objects that may be routed to different project workspaces. Alternatively or additionally, one or more portions of a request data object may be routed sequentially or simultaneously to two or more different project workspaces to allow each a project workspace to address a portion of the request data object.

Various configuration operations as to how the user experience omnichannel configuration data object may be updated are described above. It will be appreciated that such configurations may also be associated with one or more project templates and used in generation and/or updating of the user experience omnichannel configuration data object. In various embodiments, the omnichannel creation service 122 may be further used to manage an omnichannel configuration data object by allowing a user to change or update one or more configurations or settings in the omnichannel configuration data object. In an exemplary embodiment, this may provide for a leader user account to update or change channel configurations as customers may change or branding may be updated.

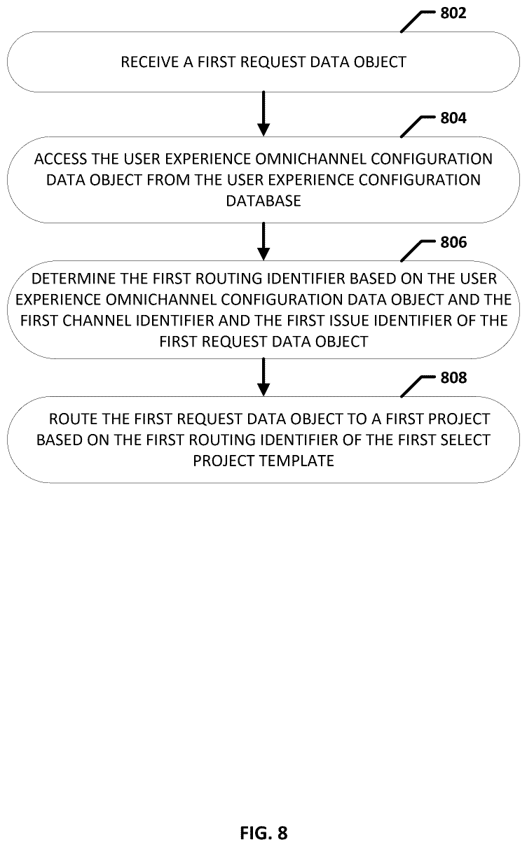

FIG. 8 illustrates a flowchart of operations associated with using a user experience omnichannel configuration data object in accordance with one or more embodiments of the present disclosure. One or more operations described in FIG. 8 may be performed by the omnichannel routing service 124, which may be in conjunction with utilizing one or more other of the system services 114.

At operation 802, receive a first request data object. A first request data object may be submitted by an experience user associated with an experience user account to the software management system 110 via first channel. The first request data object may be received through the external application interface service 128.

At operation 804, access the user experience omnichannel configuration data object from the user experience omnichannel configuration database. The user experience omnichannel configuration data object was previously generated and stored on the user experience omnichannel configuration database. The software management system 110, having received a request data object, may access the user experience omnichannel configuration data object. To do this the software management system 110 may transmit a request to user experience omnichannel configuration database to access the user experience omnichannel configuration data object.

At operation 806, determine the first routing identifier based on the user experience omnichannel configuration data object and the first channel identifier and the first issue identifier of the first request data object. On accessing the user experience omnichannel configuration data object, the software management system 110 may determine from the user experience omnichannel configuration data object how to route the first request data object.

At operation 808, route the first request data object to a first project based on the first routing identifier of the first selected project template. The software management system 110 may route the first request data object to a first project workspace based on a routing identifier. The routing identifier having been associated with the first selected project template when the user experience omnichannel configuration data object was generated and updated before being stored.

It should be readily appreciated that the embodiments of the systems, apparatuses, methods, and computer program products described herein may be configured in various additional and alternative manners in addition to those expressly described herein.

### Conclusion

Operations and/or functions of the present disclosure have been described herein, such as in flowcharts. As will be appreciated, computer program instructions may be loaded onto a computer or other programmable apparatus (e.g., hardware) to produce a machine, such that the resulting computer or other programmable apparatus implements the operations and/or functions described in the flowchart blocks herein. These computer program instructions may also be stored in a computer-readable memory that may direct a computer, processor, or other programmable apparatus to operate and/or function in a particular manner, such that the instructions stored in the computer-readable memory produce an article of manufacture, the execution of which implements the operations and/or functions described in the flowchart blocks. The computer program instructions may also be loaded onto a computer, processor, or other programmable apparatus to cause a series of operations to be performed on the computer, processor, or other programmable apparatus to produce a computer-implemented process such that the instructions executed on the computer, processor, or other programmable apparatus provide operations for implementing the functions and/or operations specified in the flowchart blocks. The flowchart blocks support combinations of means for performing the specified operations and/or functions and combinations of operations and/or functions for performing the specified operations and/or functions. It will be understood that one or more blocks of the flowcharts, and combinations of blocks in the flowcharts, may be implemented by special purpose hardware-based computer systems which perform the specified operations and/or functions, or combinations of special purpose hardware with computer instructions.

While this specification contains many specific embodiments and implementation details, these should not be construed as limitations on the scope of any disclosures or of what may be claimed, but rather as descriptions of features specific to particular embodiments of particular disclosures. Certain features that are described herein in the context of separate embodiments may also be implemented in combination in a single embodiment. Conversely, various features that are described in the context of a single embodiment may also be implemented in multiple embodiments separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

While operations and/or functions are illustrated in the drawings in a particular order, this should not be understood as requiring that such operations and/or functions be performed in the particular order shown or in sequential order, or that all illustrated operations be performed, to achieve desirable results. In certain circumstances, operations and/or functions in alternative ordering may be advantageous. In some cases, the actions recited in the claims may be performed in a different order and still achieve desirable results. Thus, while particular embodiments of the subject matter have been described, other embodiments are within the scope of the following claims.

1. An apparatus comprising at least one processor and at least one non-transitory memory including computer-coded instructions thereon, the computer coded instructions, with the at least one processor, configure the apparatus to:
receive, from a first computing device associated with a first leader user account, a user experience omnichannel generation request;
generate, in response to receipt of the first user experience omnichannel generation request, a user experience omnichannel configuration data object;
access an experience definition configuration database for a plurality of project templates associated with the user experience omnichannel configuration data object, wherein each project template of the plurality of project templates is associated with one or more project parameters, one or more omnichannel parameters, and one or more channel parameters;
receive, from the first computing device, one or more project template selection indications, wherein each project template selection indication identifies a selected project template of the plurality of project templates and identifies at least one project parameter, at least one omnichannel parameter, and at least one channel parameters;
update the user experience omnichannel configuration data object based on the one or more project template selection indications to store the selected project template associated with at least one project parameter, at least one omnichannel parameter, and at least one channel parameter; and
transmit the user experience omnichannel configuration data object to a user experience omnichannel configuration database.

2. The apparatus of claim 1, wherein, for a first selected template, the at least one project parameter includes a first project identifier, the at least one channel parameter includes a first channel identifier and a first issue identifier, and the at least one omnichannel parameter includes a first routing identifier, wherein the routing identifier associates the first channel identifier and first issue identifier with the first project identifier.

3. The apparatus of claim 2, wherein the computer-coded instructions, with the at least one processor, further configure the apparatus to:
receive, from a second computing device associated with an experience user account, a first request data object associated with a request issue identifier via a first channel, wherein the first channel is associated with the first channel identifier, and wherein the request issue identifier is the first issue identifier;
access the user experience omnichannel configuration data object from the user experience omnichannel configuration database;
determine the first routing identifier based on the user experience omnichannel configuration data object and the first channel identifier and the first issue identifier of the first request data object; and
route the first request data object to a first project based on the first routing identifier of the first selected project template.

4. The apparatus of claim 3, wherein route the first request data object to a first project based on the first routing identifier of the first selected project template includes to route the first request data object to an agent account associated with the first project.

5. The apparatus of claim 1, wherein the at least one project parameter includes at least one of a first issue type identifier and a first agent account permission identifier.

6. The apparatus of claim 1, wherein the at least one omnichannel parameter includes at least one of an experience user permission identifier, brand identifier, service identifier, and knowledge base identifier.

7. The apparatus of claim 1, wherein the at least one channel parameter includes at least one of a channel identifier, a priority identifier, and a request template identifier.

8. A computer-implemented method comprising:
receiving, from a first computing device associated with a first leader user account, a user experience omnichannel generation request;
generating, in response to receipt of the first user experience omnichannel generation request, a user experience omnichannel configuration data object;
accessing an experience definition configuration database for a plurality of project templates associated with the user experience omnichannel configuration data object, wherein each project template of the plurality of project templates is associated with one or more project parameters, one or more omnichannel parameters, and one or more channel parameters;
receiving, from the first computing device, one or more project template selection indications, wherein each project template selection indication identifies a selected project template of the plurality of project templates and identifies at least one project parameter, at least one omnichannel parameter, and at least one channel parameters;
updating the user experience omnichannel configuration data object based on the one or more project template selection indications to store the selected project template associated with at least one project parameter, at least one omnichannel parameter, and at least one channel parameter associated with a first channel group; and
transmitting the user experience omnichannel configuration data object to a user experience omnichannel configuration database.

9. The computer-implemented method of claim 8, wherein, for a first selected template, the at least one project parameter includes a first project identifier, the at least one channel parameter includes a first channel identifier and a first issue identifier, and the at least one omnichannel parameter includes a first routing identifier, wherein the routing identifier associates the first channel identifier and first issue identifier with the first project identifier.

10. The computer-implemented method of claim 9 further comprising:
receiving, from a second computing device associated with an experience user account, a first request data object associated with a request issue identifier via a first channel, wherein the first channel is associated with the first channel identifier, and wherein the request issue identifier is the first issue identifier;
accessing the user experience omnichannel configuration data object from the user experience omnichannel configuration database;
determining the first routing identifier based on the user experience omnichannel configuration data object and the first channel identifier and the first issue identifier of the first request data object; and
routing the first request data object to a first project based on the first routing identifier of the first selected project template.

11. The computer-implemented method of claim 10, wherein route the first request data object to a first project based on the first routing identifier of the first selected project template includes to route the first request data object to an agent account associated with the first project.

12. The computer-implemented method of claim 8, wherein the at least one project parameter includes at least one of a first issue type identifier and a first agent account permission identifier.

13. The computer-implemented method of claim 8, wherein the at least one omnichannel parameter includes at least one of an experience user permission identifier, brand identifier, service identifier, and knowledge base identifier.

14. The computer-implemented method of claim 8, wherein the at least one channel parameter includes at least one of a channel identifier, a priority identifier, and a request template identifier.

15. A computer program product comprising at least one non-transitory computer-readable storage medium having computer-readable program code portions stored therein, the computer-readable program code portions configured to:
receive, from a first computing device associated with a first leader user account, a user experience omnichannel generation request;
generate, in response to receipt of the first user experience omnichannel generation request, a user experience omnichannel configuration data object;
access an experience definition configuration database for a plurality of project templates associated with the user experience omnichannel configuration data object, wherein each project template of the plurality of project templates is associated with one or more project parameters, one or more omnichannel parameters, and one or more channel parameters;
receive, from the first computing device, one or more project template selection indications, wherein each project template selection indication identifies a selected project template of the plurality of project templates and identifies at least one project parameter, at least one omnichannel parameter, and at least one channel parameters; wherein the at least one omnichannel parameter is associated with at least a programmatic routing workspace;
update the user experience omnichannel configuration data object based on the one or more project template selection indications to store the selected project template associated with at least one project parameter, at least one omnichannel parameter, and at least one channel parameter; and
transmit the user experience omnichannel configuration data object to a user experience omnichannel configuration database.

16. The computer-program product of claim 15, wherein, for a first selected template, the at least one project parameter includes a first project identifier, the at least one channel parameter includes a first channel identifier and a first issue identifier, and the at least one omnichannel parameter includes a first routing identifier, wherein the routing identifier associates the first channel identifier and first issue identifier with the first project identifier.

17. The computer-program product of claim 16, wherein the at least one non-transitory computer-readable storage medium having computer-readable program code portions stored therein, further configure the computer-readable program code portions to:
receive, from a second computing device associated with an experience user account, a first request data object associated with a request issue identifier via a first channel, wherein the first channel is associated with the first channel identifier, and wherein the request issue identifier is the first issue identifier;
access the user experience omnichannel configuration data object from the user experience omnichannel configuration database;
determine the first routing identifier based on the user experience omnichannel configuration data object and the first channel identifier and the first issue identifier of the first request data object; and
route the first request data object to a first project based on the first routing identifier of the first selected project template.

18. The computer-program product of claim 17, wherein route the first request data object to a first project based on the first routing identifier of the first selected project template includes to route the first request data object to an agent account associated with the first project.

19. The computer-program product of claim 15, wherein the at least one project parameter includes at least one of a first issue type identifier and a first agent account permission identifier.

20. The computer-program product of claim 15, wherein the at least one omnichannel parameter includes at least one of an experience user permission identifier, brand identifier, service identifier, and knowledge base identifier.
